(19) United States
(12) Patent Application Publication
(10) Pub. No.: US 2014/0085173 A1
(43) Pub. Date: Mar. 27, 2014

(54) DRIVING CIRCUIT STRUCTURE OF LIQUID CRYSTAL PANEL

(71) Applicant: Shenzhen China Star Optoelectronics Technology Co., Ltd., Guangdong (CN)

(72) Inventors: Chengcai Dong, Guangdong (CN); Jehao Hsu, Guangdong (CN)

(73) Assignee: SHENZHEN CHINA STAR OPTOELECTRONICS TECHNOLOGY CO., LTD, Guangdong (CN)

(21) Appl. No.: 13/703,072

(22) PCT Filed: Oct. 8, 2012
(86) PCT No.: PCT/CN2012/082559

§ 371 Date: Dec. 10, 2012

(30) Foreign Application Priority Data
Sep. 27, 2012 (CN) 201210365719.6

(51) Int. Cl. G09G 3/36

(52) U.S. Cl. CPC G09G 3/36
USPC 345/87

(57) ABSTRACT

The present invention discloses a driving circuit structure of a liquid crystal panel, which mainly comprises a liquid crystal panel. The liquid crystal panel has an edge of a gate driving circuit and an edge of a source driving circuit. The edge of the gate driving circuit is provided with a plurality of gate driving COFs (chip on film). In the present invention, by gradually increasing trace widths of trace portions of the gate driving COFs along a gate scanning direction, the intensity of output signals of the gate driving COFs can be identical. Hence, it can eliminate the phenomenon of apparent boundary line that is appeared between the gate driving COFs of the liquid crystal panel, so as to increase the display quality.

### FIELD OF THE INVENTION

The present invention relates to a driving circuit structure of a liquid crystal panel, and more particularly to a driving circuit structure of a liquid crystal panel which has gradually increasing trace widths of trace portions of gate driving COFs (chip on film) along a gate scanning direction.

### BACKGROUND OF THE INVENTION

A liquid crystal display (LCD) is a type of flat panel display (FPD) which displays images by the property of the liquid crystal material. In comparison with other display devices, the LCD has the advantages in lightweight, compactness, low driving voltage and low power consumption, and thus has already become the mainstream product in the whole consumer market. In a traditional process of LCD panel, it comprises a front-end array process, a mid-end cell process and a back-end modulation process. The front-end array process is used to produce thin-film transistor (TFT) substrates (also called array substrates) and color filter (CF) substrates; the mid-end cell process is used to combine the TFT substrate with the CF substrate, then fill liquid crystal into a space therebetween, and cut to form panels with a suitable product size; and the back-end modulation process is used to execute an installation process of the combined panel, a backlight module, a panel driving circuit, an outer frame, etc.

As mentioned above, LCD driver chips are the important components of the LCD, and the main function thereof is to output the needed voltage to pixels, so as to control the twist degree of liquid crystal molecules. There are two types of LCD driver chips: one is the Source driver chip arranged on X-axis, the other is the Gate driver chip arranged on Y-axis. In other words, the Source driver chips control signals of image, and the Gate driver chips control signals of gate switch, so they have different functions for the LCD panel. Simply speaking, images of LCD are formed by scanning lines one by one. The Gate driver chip controls the vertical signals. If the scanning is started from the topmost line, the first pin of the Gate driver chip is set to be switched on, and others are set to be switched off. The signals in the Source driver chip are the real signal (horizontal), and the sent signal is only accepted by horizontal pixels of the first line. After the signal of the first line is transmitted, the second line will be the next one, while the content of the Source driver chip is changed to the second line, and the second pin of the Gate driver chip is switched on, and others is switched off, so that the data is transmitted to the second line.

Furthermore, an assembly of the driver chips of the back-end modulation process is an assembling technology to combine the packaged Source driver chips and the packaged Gate driver chip with the LCD panel. There are various packaging types of the driver chip for LCD, such as quad flat package (QFP), chip on glass (COG), tape automated bonding (TAB), chip on film (COF), etc, wherein the COF structure has flexibility and smaller circuit pitches, so as to become the mainstream technology of the package of driver chips.

Referring now to FIGS. 1 and 2, a top view of a traditional driving circuit structure of a liquid crystal panel is illustrated in FIG. 1; and a partially enlarged view of FIG. 1 is illustrated in FIG. 2. Specially explaining, for conveniently describing, FIGS. 1 and 2 are shown in simplification, wherein the number of the traces is simplified, and some of details which are unrelated to the explanation are also omitted.

As shown in FIG. 1, a traditional driving circuit structure of a liquid crystal panel mainly comprises a liquid crystal panel 90, which has an edge of a gate driving circuit 91 and an edge of a source driving circuit 92. The edge of the gate driving circuit 91 is provided with a plurality of gate driver COFs 81 along a gate scanning direction S. In addition, the edge of the source driving circuit 92 is provided with at least one source driving COF 71, and an outer side of the source driving COF 71 is further electrically connected with a circuit board 72.

Furthermore, as shown in FIG. 2, each of the gate driving COFs 81 comprises a flexible substrate 811, a gate driver chip 812 and a trace portion 813. The flexible substrate 811 is connected to the edge of the gate driving circuit 91 of the liquid crystal panel 90; the gate driver chip 812 is disposed on the flexible substrate 811; and the trace portion 813 electrically connects from the gate driver chip 812 to the edge of the gate driving circuit 91. Each of the gate driving COFs 81 on the gate driving circuit 91 of the liquid crystal panel 90 are identical in the structure thereof.

However, in actual operation, the liquid crystal panel 90 will generate one problem: the liquid crystal panel 90 will appear a boundary line between each of the gate driving COFs 81 (this phenomenon is called “H-block issue” or “Block Dim”). The main reason of this phenomenon is that: the gate driving COFs 81 are connected by wire on Array (WOA), so it causes the gate output signals of the different gate driving COFs 81 are not identical. Because a RC delay effect (by resistance and the capacitance) is produced in transmission of metal wire connection, along the gate scanning direction S, the gate output signal of a second gate driving COF 81 will be decreased than a first gate driving COF 81; and the gate output signal of a third gate driving COF 83 will be decreased than the second gate driving COF 82. Hence, when all of the liquid crystal panel 90 show an even picture, the brightness of the control regions of the three different gate driving COFs 81 will be not identical. These differences are easy to appear in the border areas between the control regions of the different gate driving COFs 81, and to form an apparent boundary line.

As a result, it is necessary to provide a driving circuit structure of a liquid crystal panel to solve the problems existing in the conventional technologies.

### SUMMARY OF THE INVENTION

A primary object of the present invention is to provide a driving circuit structure of a liquid crystal panel to solve the problem existing in the conventional technologies, the problem is: when all of the liquid crystal panel shows an even picture, the brightness of the control regions of the three different gate driving will be not identical to form an apparent boundary line.

To achieve the above object, the present invention provides a driving circuit structure of a liquid crystal panel, which mainly comprises a liquid crystal panel, wherein the liquid crystal panel has an edge of a gate driving circuit and an edge of a source driving circuit; along a gate scanning direction, the edge of the gate driving circuit is provided with a first gate driver COF (chip on film), a second gate driving COF and a third gate driving COF in turn; and each of the gate driving COFs comprises:
a flexible substrate connected to the edge of the gate driving circuit of the liquid crystal panel;
a gate driver chip disposed on the flexible substrate; and
a trace portion electrically connecting the gate driver chip to the edge of the gate driving circuit;
wherein a trace width of the trace portion of the second gate driving COF is greater than a trace width of the trace portion of the first gate driving COF; and a trace width of the trace portion of the third gate driving COF is greater than the trace width of the trace portion of the second gate driving COF.

In one embodiment of the present invention, the trace portion is a fan-out trace portion, and traces of the trace portion have a fan shape.

In one embodiment of the present invention, a trace resistance value of the trace portion of the second gate driving COF is smaller than a trace resistance value of the trace portion of the first gate driving COF; and a trace resistance value of the trace portion of the third gate driving COF is smaller than the trace resistance value of the trace portion of the second gate driving COF.

In one embodiment of the present invention, the intensity of output signals of the gate driving COFs are identical.

To achieve the above object, the present invention further provides a driving circuit structure of a liquid crystal panel, which mainly comprises a liquid crystal panel, wherein the liquid crystal panel has an edge of a gate driving circuit and an edge of a source driving circuit; along a gate scanning direction, the edge of the gate driving circuit is provided with a plurality of COFs in turn; and each of the gate driving COFs comprises:
a flexible substrate connected to the edge of the gate driving circuit of the liquid crystal panel;
a gate driver chip disposed on the flexible substrate; and
a trace portion electrically connecting the gate driver chip to the edge of the gate driving circuit;
wherein trace widths of the trace portions of the COFs are gradually increased along a gate scanning direction, and intensity of the output signals of the gate driving COFs are identical.

In one embodiment of the present invention, the trace portion is a fan-out trace portion, and traces of the trace portion have a fan shape.

In one embodiment of the present invention, trace resistance values of the trace portions of the COFs are gradually decreased along a gate scanning direction.

To achieve the above object, the present invention further provides a driving circuit structure of a liquid crystal panel, which mainly comprises a liquid crystal panel, wherein the liquid crystal panel has an edge of a gate driving circuit and an edge of a source driving circuit; along a gate scanning direction, the edge of the gate driving circuit is provided with a plurality of COFs in turn; and each of the gate driving COFs comprises:
a flexible substrate connected to the edge of the gate driving circuit of the liquid crystal panel;
a gate driver chip disposed on the flexible substrate; and
a trace portion electrically connecting the gate driver chip to the edge of the gate driving circuit;
wherein trace resistance values of the trace portions of the COFs are gradually decreased along a gate scanning direction.

In one embodiment of the present invention, the trace portion is a fan-out trace portion, and traces of the trace portion have a fan shape.

In one embodiment of the present invention, trace widths of the trace portions of the COFs are gradually increased, and intensity of the output signals of the gate driving COFs are identical.

In the present invention, by gradually increasing the trace widths of the trace portions of the gate driving COFs along the gate scanning direction (the trace resistance values are gradually decreased), the intensity of the output signals of the gate driving COFs can be identical. Hence, it can eliminate the phenomenon of apparent boundary line that is appeared between the gate driving COFs of the liquid crystal panel, so as to increase the display quality.

### DESCRIPTION OF THE DRAWINGS

FIG. 1 is a top view of a traditional driving circuit structure of a liquid crystal panel;

FIG. 2 is a partially enlarged view of FIG. 1;

FIG. 3 is a top view of a driving circuit structure of a liquid crystal panel according to the present invention; and

FIG. 4 is a partially enlarged view of FIG. 3.

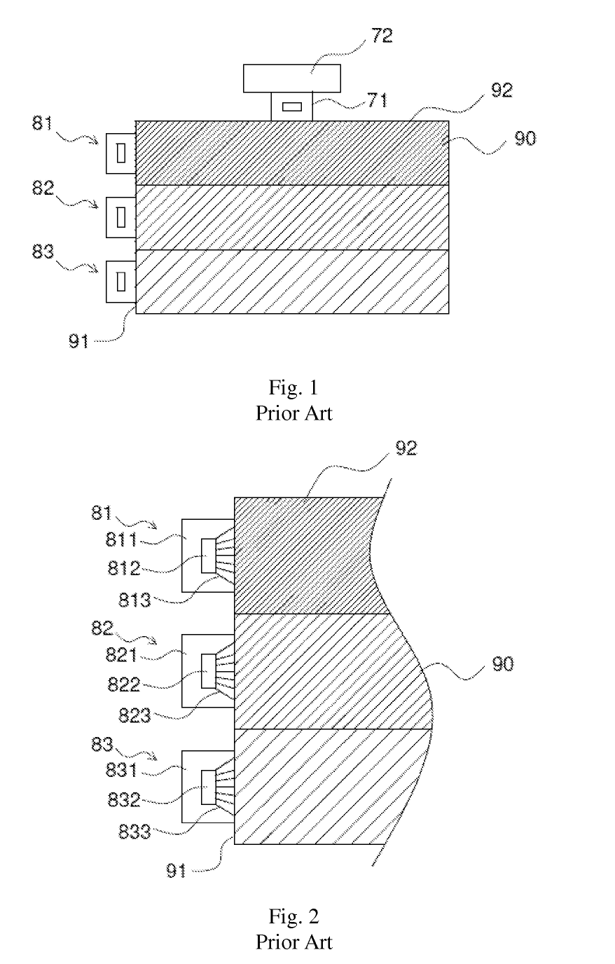

### DETAILED DESCRIPTION OF THE PREFERRED EMBODIMENTS

The foregoing objects, features and advantages adopted by the present invention can be best understood by referring to the following detailed description of the preferred embodiments and the accompanying drawings. Furthermore, the directional terms described in the present invention, such as upper, lower, front, rear, left, right, inner, outer, side and etc., are only directions referring to the accompanying drawings, so that the used directional terms are used to describe and understand the present invention, but the present invention is not limited thereto.

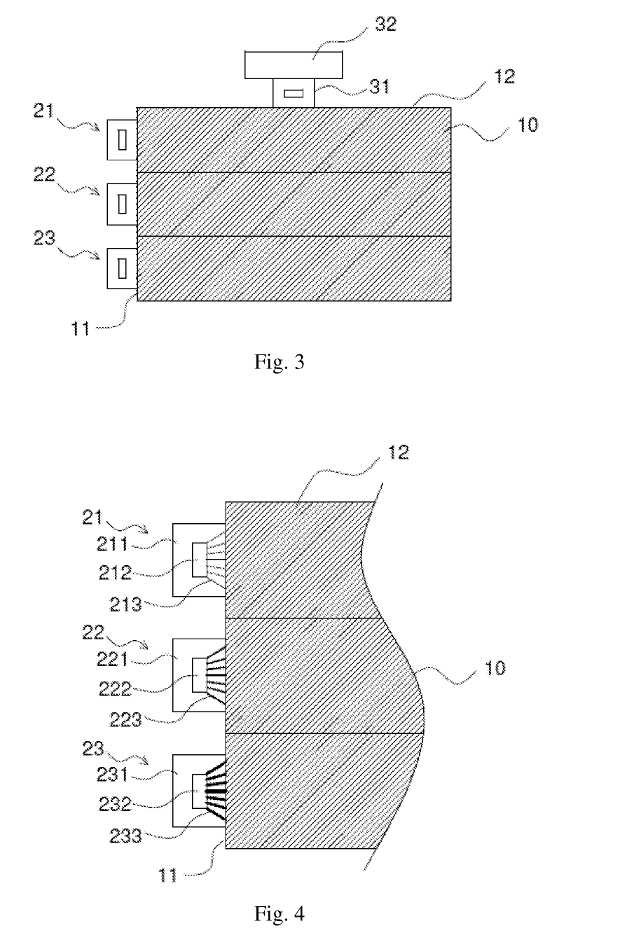

Referring now to FIGS. 3 and 4, a top view of a driving circuit structure of a liquid crystal panel according to the present invention is illustrated in FIG. 3; and a partially enlarged view of FIG. 3 is illustrated in FIG. 4. Specially explaining, for conveniently describing, FIGS. 3 and 4 are shown in simplification, wherein the number of the traces is simplified, and some of details which are unrelated to the explanation are also omitted.

As shown in FIG. 3, a driving circuit structure of a liquid crystal panel according to the present invention mainly comprises a liquid crystal panel 10, which has an edge of a gate driving circuit 11 and an edge of a source driving circuit 12. Along a gate scanning direction S, the edge of the gate driving circuit 11 is provided with a first gate driver COF (chip on film) 21, a second gate driving COF 22 and a third gate driving COF 23 in turn. In addition, the edge of the source driving circuit 12 is provided with at least one source driving COF 31, and an outer side of the source driving COF 31 is further electrically connected with a circuit board 32.

Furthermore, as shown in FIG. 4, the first gate driving COF 21 comprises a flexible substrate 211, a gate driver chip 212 and a trace portion 213. The flexible substrate 211 is connected to the edge of the gate driving circuit 11 of the liquid crystal panel 10; the gate driver chip 212 is disposed on the flexible substrate 211; and the trace portion 213 electrically connects from the gate driver chip 212 to the edge of the gate driving circuit 11. The trace portion 213 can be a fan-out trace portion, namely, the traces of the trace portion 213 have a fan shape.

In addition, the second gate driving COF 22 and the third gate driving COF 23 have structures which are similar to the structure of the first gate driving COF 21. However, the difference between the first gate driving COF 21, the second gate driving COF 22 and the third gate driving COF 23 is that: a trace width of the trace portion 223 of the second gate driving COF 22 is greater than a trace width of the trace portion 213 of the first gate driving COF 21; and a trace width of the trace portion 233 of the third gate driving COF 23 is greater than the trace width of the trace portion 223 of the second gate driving COF 22.

For detailed description, the gate driving COFs 21, 22, 23 are connected by wire on Array (WOA), so it causes the output signals of the gate driving COFs 21, 22, 23 are not identical. Because a RC delay effect (by resistance and the capacitance) is produced in transmission of metal wire connection, along the gate scanning direction S, a gate output signal of the second gate driving COF 22 will be decreased than the first gate driving COF 21; and a gate output signal of the third gate driving COF 23 will be decreased than the second gate driving COF 22.

For equalizing the output signals of the gate driving COFs 21, 22, 23, the driving circuit structure of the liquid crystal panel according to the present invention are adjusted by changing the resistance values of the traces. Specifically, because the resistance values of the traces are related to the width of the traces, the one which has a wider trace has a smaller resistance value. Hence, in the present invention, by gradually increasing the width of the traces of the gate driving COFs 21, 22, 23 along the gate scanning direction S (the trace resistance values are gradually decreased), so that the intensity of the output signals of the gate driving COFs 21, 22, 23 can be identical.

Moreover, although it is disclosed in the preferred embodiment of the present invention that the edge of the gate driving circuit 11 of the liquid crystal panel 10 is provided with three of the gate driving COFs 21, 22, 23, but it is not limited in the present invention, so that the number of the gate driving COFs can be two or more.

As described above, for the traditional COF structure, there is a phenomenon of apparent boundary line between gate driving COFs of a liquid crystal panel. In the present invention, by gradually increasing the trace widths of the trace portions of the gate driving COFs 21, 22, 23 along the gate scanning direction, the intensity of the output signals of the gate driving COFs 21, 22, 23 can be identical. Hence, the driving circuit structure of the liquid crystal panel according to the present invention can eliminate the phenomenon of apparent boundary line (“H-block issue” or “Block Dim”) that is appeared between the gate driving COFs 21, 22, 23 of the liquid crystal panel 10, so as to increase the display quality.

The present invention has been described with a preferred embodiment thereof and it is understood that many changes and modifications to the described embodiment can be carried out without departing from the scope and the spirit of the invention that is intended to be limited only by the appended claims.

1. A driving circuit structure of a liquid crystal panel, which mainly comprises a liquid crystal panel, wherein the liquid crystal panel has an edge of a gate driving circuit and an edge of a source driving circuit; along a gate scanning direction, the edge of the gate driving circuit is provided with a first gate driver chip-on-film (COF), a second gate driving COF and a third gate driving COF in turn; and each of the gate driving COFs comprises:
a flexible substrate connected to the edge of the gate driving circuit of the liquid crystal panel;
a gate driver chip disposed on the flexible substrate; and
a trace portion electrically connecting the gate driver chip to the edge of the gate driving circuit;
wherein a trace width of the trace portion of the second gate driving COF is greater than a trace width of the trace portion of the first gate driving COF; and a trace width of the trace portion of the third gate driving COF is greater than the trace width of the trace portion of the second gate driving COF.

2. The driving circuit structure of the liquid crystal panel according to claim 1, wherein the trace portion is a fan-out trace portion, and traces of the trace portion have a fan shape.

3. The driving circuit structure of the liquid crystal panel according to claim 1, wherein a trace resistance value of the trace portion of the second gate driving COF is smaller than a trace resistance value of the trace portion of the first gate driving COF; and a trace resistance value of the trace portion of the third gate driving COF is smaller than the trace resistance value of the trace portion of the second gate driving COF.

4. The driving circuit structure of the liquid crystal panel according to claim 1, wherein the intensity of output signals of the gate driving COFs are identical.

5. A driving circuit structure of a liquid crystal panel, which mainly comprises a liquid crystal panel, wherein the liquid crystal panel has an edge of a gate driving circuit and an edge of a source driving circuit; along a gate scanning direction, the edge of the gate driving circuit is provided with a plurality of COFs in turn; and each of the gate driving COFs comprises:
a flexible substrate connected to the edge of the gate driving circuit of the liquid crystal panel;
a gate driver chip disposed on the flexible substrate; and
a trace portion electrically connecting the gate driver chip to the edge of the gate driving circuit;
wherein trace widths of the trace portions of the COFs are gradually increased along a gate scanning direction, and intensity of output signals of the gate driving COFs are identical.

6. The driving circuit structure of the liquid crystal panel according to claim 5, wherein the trace portion is a fan-out trace portion, and traces of the trace portion have a fan shape.

7. The driving circuit structure of the liquid crystal panel according to claim 5, wherein trace resistance values of the trace portions of the COFs are gradually decreased along a gate scanning direction.

8. A driving circuit structure of a liquid crystal panel, which mainly comprises a liquid crystal panel, wherein the liquid crystal panel has an edge of a gate driving circuit and an edge of a source driving circuit; along a gate scanning direction, the edge of the gate driving circuit is provided with a plurality of COFs in turn; and each of the gate driving COFs comprises:
a flexible substrate connected to the edge of the gate driving circuit of the liquid crystal panel;
a gate driver chip disposed on the flexible substrate; and
a trace portion electrically connecting the gate driver chip to the edge of the gate driving circuit;
wherein trace resistance values of the trace portions of the COFs are gradually decreased along a gate scanning direction.

9. The driving circuit structure of the liquid crystal panel according to claim 8, wherein the trace portion is a fan-out trace portion, and traces of the trace portion have a fan shape.

10. The driving circuit structure of the liquid crystal panel according to claim 8, wherein trace widths of the trace portions of the COFs are gradually increased, and intensity of output signals of the gate driving COFs are identical.
